(19) United States
(12) Patent Application Publication
(10) Pub. No.: US 2009/0046779 A1
(43) Pub. Date: Feb. 19, 2009

(54) Method and apparatus for determining block mode using bit-generation probability estimation in moving picture coding

(75) Inventors: Jin Wuk Seok, Daejeon (KR); Jeong Woo Lee, Daejeon (KR); Kyoung Ill Kim, Daejeon (KR); Chang Sik Cho, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/155,840

(22) Filed: Jun. 10, 2008

(30) Foreign Application Priority Data
Aug. 16, 2007 (KR) 10-2007-0082078

(51) Int. Cl. H04N 7/32; H04N 7/26

(52) U.S. Cl. 375/240.03; 375/240.16; 375/E07.14

(57) ABSTRACT

Provided are a method and apparatus for determining a block mode using bit-generation probability estimation in motion picture coding. In H.264 video coding for Internet protocol (IP)-television (TV), the method and apparatus first determine whether or not a current block mode is a skip mode or a direct-prediction mode using bit-generation probability estimation, thereby reducing the amount of computation. By minimizing the amount of computation for determining a block mode, it is possible to increase an encoding rate and also minimize deterioration in image quality.

### CROSS-REFERENCE TO RELATED APPLICATION

This application claims priority to and the benefit of Korean Patent Application No. 2007-82078, filed Aug. 16, 2007, the disclosure of which is incorporated herein by reference in its entirety.

### BACKGROUND

1. Field of the Invention

The present invention relates to a method and apparatus for determining a block mode using bit-generation probability estimation in moving picture coding, and more particularly, to H.264 video coding technology for Internet protocol (IP)-television (TV) that estimates a bit-generation probability using an average value and a variance value of each block and determines whether or not a current block mode is a skip mode or a direct-prediction mode using the bit-generation probability, and thus can minimize the amount of computation for H.264 video coding and deterioration in image quality.

2. Discussion of Related Art

Digital video data is used in video conferencing, High Definition TVs (HDTVs), Video-on-Demand (VOD) receivers, personal computers (PCs) supporting Moving Picture Experts Group (MPEG) images, game consoles, terrestrial digital broadcast receivers, digital satellite broadcast receivers, cable TVs (CATVs), and so on. Since digital video data has image characteristics and significantly increases in amount during the process of digitizing an analog signal, it is compressed by an efficient compression method rather than being used as it is.

Digital image data is mainly compressed by 3 types of methods, which are a compression method using temporal redundancy, a compression method using spatial redundancy and a compression method using a statistical characteristic of a generated code. Among the 3 methods, a typical compression method using temporal redundancy is motion estimation and compensation, which is used in most moving picture compression standards such as MPEG, H.263, and so on.

The motion estimation and compensation method searches for the most similar portion in a specific portion between the current screen and a previous or next reference screen, and transfers only a difference component between the two portions. The method can reduce data effectively because the difference component to be transferred is reduced as a motion vector can be found as accurately as possible. However, a considerable amount of estimation time and a considerable amount of computation are required to determine the most similar portion in the previous or next frame. Therefore, research into reducing a motion estimation time, which takes the most time when encoding moving pictures, is ongoing.

Meanwhile, there are two main types of motion estimation methods. One is a pixel-by-pixel basis estimation method, and the other is a block-by-block basis estimation method, which is the most widely used algorithm.

The block-by-block basis estimation method divides an image into blocks of a predetermined magnitude and finds a block best matching a current image block within a search region of a previous image. A difference between the found block and the current image block is called a motion vector. The block-by-block basis estimation method is used to encode the motion vector and process the encoded motion vector. To calculate the degree of matching between two blocks, various matching functions can be used. The most generally used matching function is a Sum of Absolute Difference (SAD) calculated by summing all absolute values of differences between pixels in the two blocks.

In the case of an H.264 codec, a search is performed using a cost function based on Rate-Distortion Optimization (RDO) instead of a conventional SAD-based search method. The cost function used in H.264 performs a search using a rate-distortion cost, which is calculated by summing an existing SAD value and a value obtained by multiplying the number of encoded coefficients by a Lagrange multiplier. Here, the number of the encoded coefficients is substituted by and determined to be a value proportional to a quantization coefficient value, and a cost value is determined by multiplying the determined number of encoded coefficients by a fixed Lagrange multiplier. Based on the cost value, the search is performed.

In conventional moving picture coding, an encoding operation is performed in units of a 16×16 or an 8×8 block to obtain high compression efficiency and high image quality. On the other hand, in H.264 video coding, a block mode having a minimum value is selected from 8 kinds of different block modes.

However, in order to determine one of the 8 kinds of different block modes, main pixels and sub-pixels must be searched for each block mode, and also various kinds of encoding operations must be independently performed for each block mode. Thus, H.264 video coding requires a large amount of computation and consumes a large amount of computation time.

### SUMMARY OF THE INVENTION

The present invention is directed to a method and apparatus for determining a block mode using a bit-generation probability in H.264 video coding for Internet protocol (IP)-television (TV), thus capable of minimizing the amount of computation for determining a block mode and deterioration in image quality.

One aspect of the present invention provides a method of determining a block mode using bit-generation probability estimation in moving picture coding, the method comprising: a performing motion estimation for an input image frame and determining a current macroblock and a corresponding reference macroblock; a calculating an average value and a variance value between the determined current macroblock and the determined corresponding reference macroblock; a calculating a bit-generation probability estimation value between the macroblocks using the average value and the variance value between the macroblocks; and a determining whether or not a current block mode requires additional motion estimation according to the calculated bit-generation probability estimation value.

Another aspect of the present invention provides an apparatus for determining a block mode using bit-generation probability estimation in moving picture coding, the apparatus comprising a motion estimator comprising: a motion estimation unit for performing motion estimation for an input image frame; and a block mode determination unit for determining whether or not a current block mode requires additional motion estimation using an average value and a variance value between a current macroblock determined by the motion estimation and a corresponding reference macroblock.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of an H.264 video encoder for Internet protocol (IP)-television (TV) to which the present invention is applied;

FIGS. 2A and 2B illustrate inter modes of H.264 and intra 4×4 modes of H.264, respectively;

FIG. 3 is a block diagram of a motion estimator in the video encoder shown in FIG. 1;

FIG. 4 is a graph showing similarity between a Discrete Cosine Transform (DCT) function and a probability density function for estimating a bit-generation probability according to the present invention;

FIG. 5 is a flowchart showing a method of determining a block mode using bit-generation probability estimation according to an exemplary embodiment of the present invention; and

FIG. 6 illustrates a method of determining a block mode using bit-generation probability estimation according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various ways. The following embodiments are described in order to enable those of ordinary skill in the art to embody and practice the present invention.

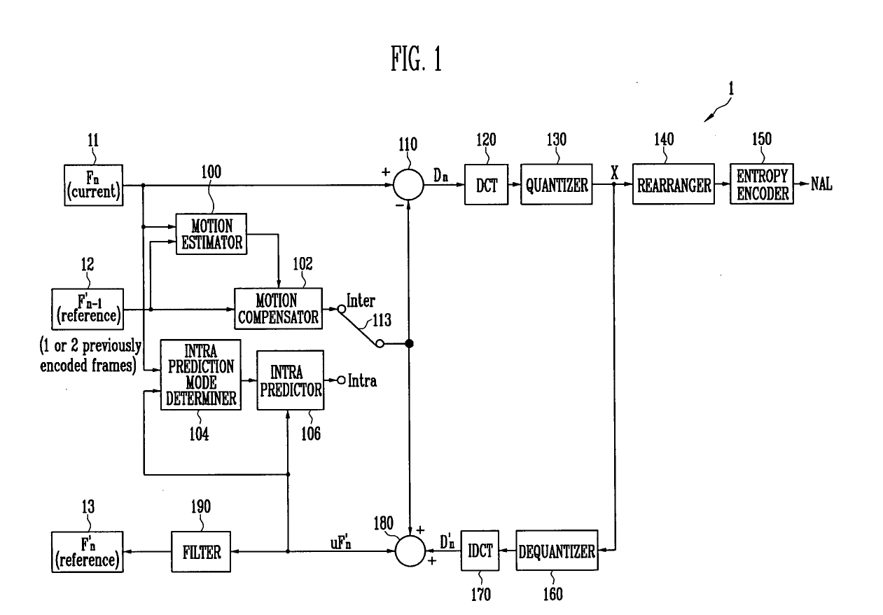

FIG. 1 is a block diagram of an H.264 video encoder 1 for Internet protocol (IP)-television (TV) to which the present invention is applied.

In FIG. 1, a current image 11 is denoted by Fₙ(current), images 12 restored one unit hour previously in the encoder 1 by a motion compensator 102 are denoted by F′ₙ₋₁ (reference), and a restored image 13, which is the same as an image decoded by a decoder, of the current image is denoted by F′ₙ. Here, n denotes a time index.

The video encoder 1 shown in FIG. 1 encodes the currently input image 11 having units of a macroblock in an intra mode and an inter mode. To this end, H.264 supports 8 inter modes, i.e., a skip mode, an inter 16×16 mode, an inter 16×8 mode, an inter 8×16 mode, an inter 8×8 mode, an inter 8×4 mode, an inter 4×8 mode and an inter 4×4 mode, and 3 intra modes, i.e., an intra 4×4 mode, an intra 8×8 mode and an intra 16×16 mode. Here, 4 inter modes, that is, the inter 8×8 mode, the inter 8×4 mode, the inter 4×8 mode and the inter 4×4 mode are referred to as P8×8.

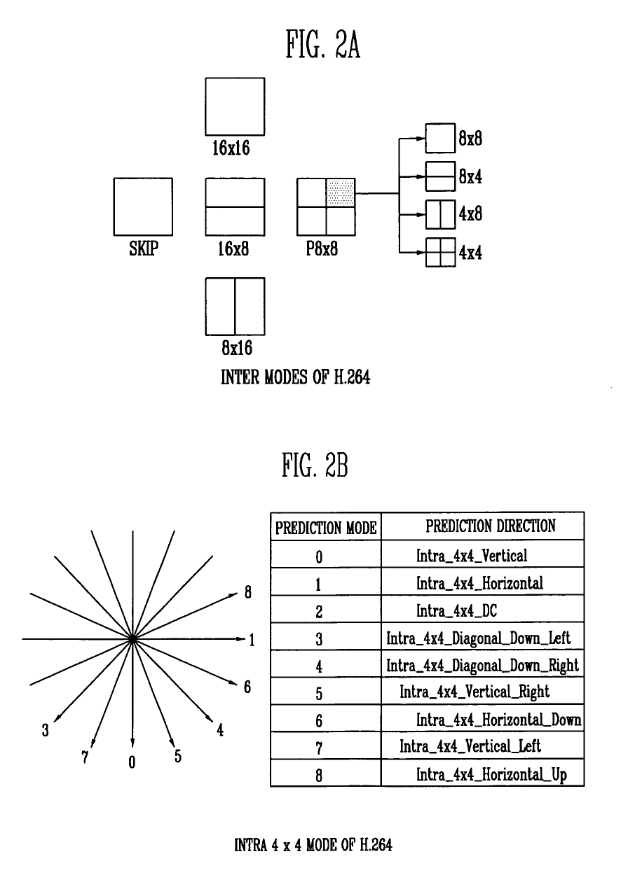

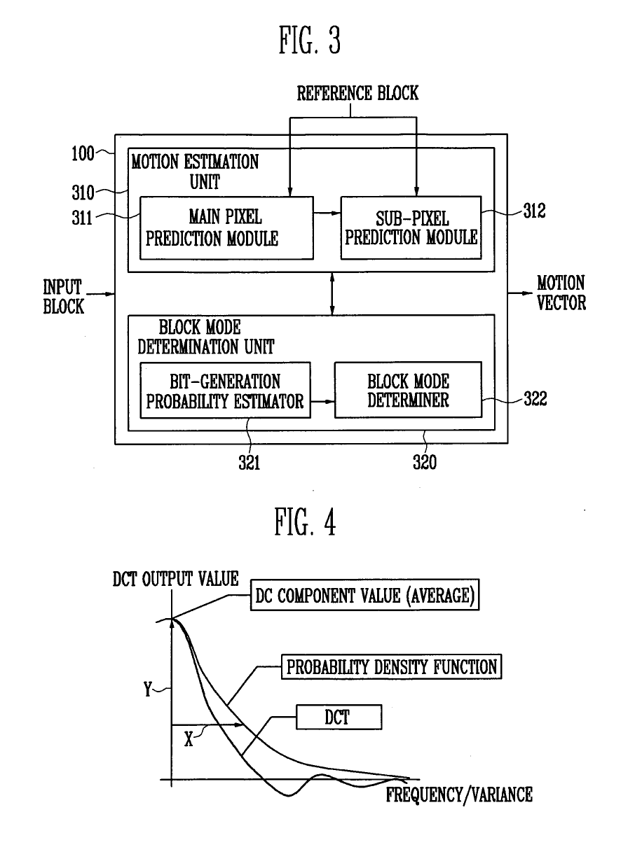

FIG. 2A illustrates inter modes of H.264. In the inter modes, motion estimation is performed in units of a skip block, a 16×16 block, a 16×8 block, an 8×16 block, and P8×8 blocks to predict a current macroblock. FIG. 2B illustrates the intra 4×4 mode of H.264. In the intra 4×4 mode, a current macroblock is predicted in units of a 4×4 block using 9 prediction directions.

Referring to FIG. 1 again, a motion estimator 100 receives the previously restored reference images 12 and performs motion estimation for the currently input image 11 having units of a macroblock, thereby obtaining a motion vector. The motion compensator 102 generates a motion-compensated image using the motion vector obtained by the motion estimator 100 and the previously restored reference images 12, and outputs the image to a subtractor 110.

Here, an intra prediction mode determiner 104 receives a currently input image frame having units of a macroblock and the previously restored reference images, determines an intra prediction mode and outputs the mode to an intra predictor 106. The intra predictor 106 generates an image compensated for difference in color and luminance and outputs the image to the subtractor 110.

The subtractor 110 outputs a difference image Dn among an input macroblock, a macroblock motion-compensated by the motion compensator 102 and the image compensated for difference in color and luminance by the intra predictor 106. The output difference image Dn is quantized in units of a block by a Discrete Cosine Transformer (DCT) 120 and a quantizer 130.

An image frame quantized in units of a block is rearranged for variable length coding by a rearranger 140, and the rearranged image is entropy-encoded by an entropy encoder 150 and output in the form of Network Abstraction Layer (NAL) unit data.

While the encoding is going on, the quantized image output from the quantizer 130 is decoded by a dequantizer 160 and Inverse Discrete Cosine Transformer (IDCT) 170. The decoded image is input to an adder 180, and the motion-compensated macroblock output from the motion compensator 102 and a color difference and luminance-compensated macroblock output from the intra predictor 106 are added to the decoded image, thereby performing image restoration, i.e., motion compensation.

The restored image is passed through a filter 190 for enhancing image quality and then is stored as F′ₙ 13, which is referred to as F′ₙ₋₁ when a next image is encoded.

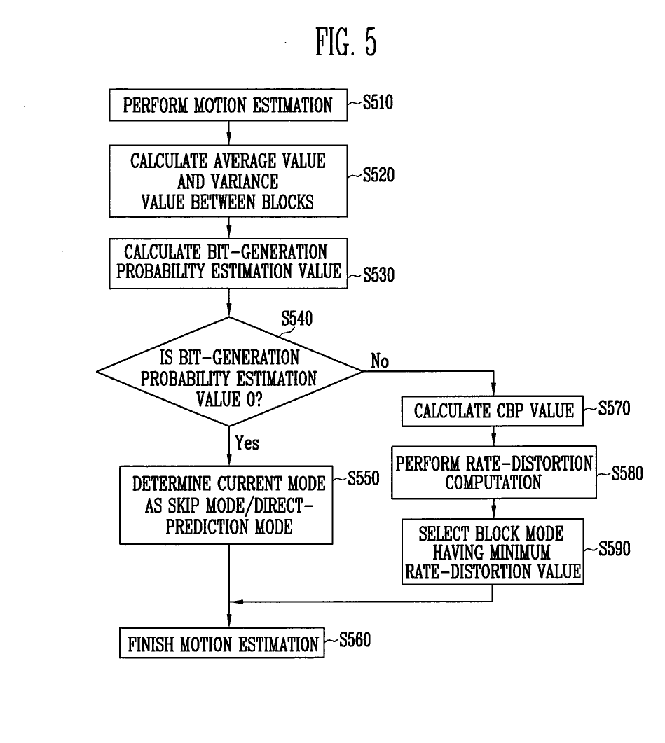

The most remarkable characteristic of the present invention is that in the H.264 video encoder 1 constituted as shown in FIG. 1, the motion estimator 100 rapidly determines a block mode by estimating a bit-generation probability and thus prevents deterioration in image quality while minimizing the amount of encoding computation. This will be described in further detail with reference to FIGS. 3 and 4.

FIG. 3 is a block diagram of the motion estimator 100 in the video encoder 1 shown in FIG. 1, and FIG. 4 is a graph showing similarity between a DCT function and a probability density function for estimating a bit-generation probability according to the present invention.

As illustrated in FIG. 3, the motion estimator 100 comprises a motion estimation unit 310 for motion estimation, and a block mode determination unit 320 for determining a block mode according to the motion estimation result. The motion estimation unit 310 includes a main pixel prediction module 311 and a sub-pixel prediction module 312, and the block mode determination unit 320 includes a bit-generation probability estimator 321 and a block mode determiner 322.

First, in order to facilitate understanding of the present invention, differences between conventional art and the present invention will be described.

According to the conventional art, 4×4 DCT and quantization operations are performed, and a Coded Block Pattern (CBP) is obtained using the operation result. Then, using the CBP, it is determined whether or not a current mode is the skip mode in the case of a Predicted (P) frame, or it is determined whether or not a current mode is a direct-prediction mode in the case of a Bidirectionally predicted (B) frame. Subsequently, main pixel and sub-pixel estimation is performed for other modes except the skip mode and the direct-prediction mode, and rate-distortion computation is performed according to the result, thereby selecting a block mode having the minimum rate-distortion cost. Therefore, the amount of computation unnecessarily increases due to the DCT and quantization operations for obtaining a CBP value.

To solve this problem, the present invention does not perform DCT and quantization operations after finishing first main pixel and sub-pixel estimation, but calculates a bit-generation probability estimation value using an average value and a variance value between blocks, thereby determining whether or not a current mode is a skip mode or a direct-prediction mode. Such a principle of the present invention will be described in detail below using equations.

First, when XεR^{4×4} is a DCT result of motion-compensated 4×4 pixel data, 4×4 pixel data (X_{Q}εR^{4×4}) obtained by quantizing the DCT result may be expressed by Equation 1 below.

$${X}_{Q} ( i , j ) = \frac{X ( i , j ) \cdot Q [ ( QP + 12 ) \%6 , i , j ] + 2 f}{{2}^{16 + \frac{QP + 12}{6}}} \qquad Equation 1$$

In Equation 1, X_{Q}(i,j) denotes an element in an i-th column and a j-th row of quantized XεR^{4×4}, X(i,j) denotes an element in an i-th column and a j-th row of XεR^{4×4} before being quantized, QP denotes a quantization coefficient of H.264, Q[(QP+12) % 6, i, j) denotes a quantization function of QP, i and j depending on i, j and a remainder obtained by dividing a result of adding 12 to the quantization coefficient by 6, and f denotes a quantization level offset value.

In Equation 1, a CBP value of a 4×4 block equals 1 when any of the quantization coefficients is not 0, and otherwise the CBP value equals 0.

In other words, according to the conventional art, it is determined using the CBP value calculated by Equation 1 whether or not a current mode is a skip mode or a direct-prediction mode, and thus a large amount of computation is required.

In comparison with this, as illustrated in FIG. 4, the block mode determination unit 320 of the present invention considers a result of a DCT operation as that of a two-dimensional Gaussian probability density function to calculate a bit-generation probability estimation value using an average value and a variance value between blocks, thereby first determining whether or not a current mode is a skip mode or a direct-prediction mode. This will be described in further detail below.

FIG. 4 is a graph showing similarity between a DCT output value and a two-dimensional Gaussian probability density function for estimating a bit-generation probability according to the present invention. As illustrated in FIG. 4, variance of the DCT output value is similar to that of the two-dimensional Gaussian probability density function.

According to the similarity between the DCT output value and the two-dimensional Gaussian probability density function, a DCT output value Y obtained when a frequency/variance value X equals 0 may be considered as an average or a DC component value of DCT output values.

Therefore, from a DCT output value of a 4×4 block, an average value m_{4×4} between blocks may be calculated by Equation 2 below, and a variance value V_{4×4} between blocks may be calculated by Equation 3 below.

$$\begin{matrix}{m}_{4 \times 4} = {\sum }_{i = 0}^{3} {\sum }_{j = 0}^{3} ( P ( i , j , t - 1 ) - \overline{P} ( i , j , t ) ) & Equation 2 \\ {V}_{4 \times 4} = \frac{1}{16} {\sum }_{i = 0}^{3} {\sum }_{j = 0}^{3} {( P ( i , j , t - 1 ) - {m}_{4 \times 4} )}^{2} & Equation 3\end{matrix}$$

In Equations 2 and 3, P(i,j,t-k) denotes a pixel value in an i-th column and a j-th row of a unit 4×4 block at a time of (t-k), P̅(i, j, t) denotes a pixel value in an i-th column and a j-th row of a 4×4 block estimated using P(i,j,t-k), and m_{4×4} denotes an average value calculated in the unit 4×4 block.

Using the thus-calculated average value m_{4×4} and variance value V_{4×4}, a bit-generation probability estimation value Eh(m_{4×4}, V_{4×4}, QP) between blocks is calculated by Equation 4 below.

$$Eh ( {m}_{4 \times 4} , {V}_{4 \times 4} , QP ) = \frac{{m}_{4 \times 4} \cdot Q [ ( QP + 12 ) \%6 , 0 , 0 ] + 2 f}{{2}^{16 + \frac{QP + 12}{6}}} + u ( {V}_{4 \times 4} - ( 15 + {θ}_{t} ) ) \qquad Equation 4$$

In Equation 4, m_{4×4} denotes an average value calculated in a unit 4×4 block, V_{4×4} denotes a variance value calculated in the unit 4×4 block, QP denotes a quantization coefficient of H.264, Q[(QP+12) % 6, i, j) denotes a quantization function of QP, i and j depending on i, j and a remainder obtained by dividing a result of adding 12 to the quantization coefficient by 6, f denotes a quantization level offset value, u(x) denotes a unit step function having a value of 1 when x≧0 and a value of 0 when x<0, and θ denotes a threshold value for estimating a bit-generation probability and is calculated by a least square method to be 2.5 to 3.5.

The bit-generation probability estimation value between blocks calculated by Equation 4 has a value of 0 or 1, which is the same as the CBP value. When the bit-generation probability estimation value between blocks is 0, the block mode determiner 322 determines that a current mode is a skip mode or a direct-prediction mode not requiring any further motion estimation.

In other words, according to the conventional art, a large amount of computation is required. This is because DCT and quantization are performed after main pixel and sub-pixel estimation is finished, a CBP value is obtained using the result, and then it is determined whether or not a current mode is a skip mode or a direct-prediction mode using the CBP value. On the other hand, according to the present invention, it is possible to reduce the amount of computation. This is because when all of 16 bit-generation probability estimation values calculated by Equation 4 are 0, it is possible to immediately determine whether or not a current mode is a skip mode or a direct-prediction mode after main pixel and sub-pixel estimation is finished.

Using a bit-generation probability estimation value between blocks calculated by Equation 4, a block mode for the P frame is determined, which shows an accuracy equal to or more than about 75%.

Meanwhile, a block mode may be incorrectly determined by Equation 4. In a first case, a current mode is not determined as a skip mode or a direct-prediction mode, even though it is the skip mode or the direct-prediction mode. In a second case, a current mode is determined as a skip mode or a direct-prediction mode even though it is not the skip mode or the direct-prediction mode. In the first case, it does not matter because the current mode is corrected to the skip mode or the direct-prediction mode. However, in the second case, image quality may deteriorate. Therefore, in Equation 4, the threshold value θ for estimating a bit-generation probability may be reduced from the value of 2.5 to 3.5, which is calculated by the least square method, by about 10%.

On the other hand, in case of the B frame, a bit-generation probability may be correctly estimated by bidirectional, i.e., forward and backward, prediction. Thus, a bit-generation probability estimation value Eh(m_{4×4}, V_{4×4}, QP) between blocks is calculated by Equation 5 below obtained by simplifying Equation 4.

$$Eh ( {m}_{4 \times 4} , {V}_{4 \times 4} , QP ) = \frac{{m}_{4 \times 4} \cdot Q [ ( QP + 12 ) \%6 , 0 , 0 ] + 2 f}{{2}^{16 + \frac{QP + 12}{6}}} \qquad Equation 5$$

In Equation 5, m_{4×4} denotes an average value calculated in a unit 4×4 block, V_{4×4} denotes a variance value calculated in the unit 4×4 block, QP denotes a quantization coefficient of H.264, Q[(QP+12) % 6, i, j) denotes a quantization function of QP, i and j depending on i, j and a remainder obtained by dividing a result of adding 12 to the quantization coefficient by 6, and f denotes a quantization level offset value.

Using a bit-generation probability estimation value between blocks calculated by Equation 5, a block mode for the B frame is determined, which shows a high accuracy equal to or more than about 97%.

In this way, the method of determining a block mode according to an exemplary embodiment of the present invention can rapidly determine whether or not a current mode is a skip mode or a direct-prediction mode using only an average value and a variance value between blocks. In comparison with a conventional method of determining a block mode using DCT, it is possible to rapidly determine whether or not a current mode is a skip mode or a direct-prediction mode with about 50% of the amount of computation, and an actual encoding rate increases by 10 to 20%.

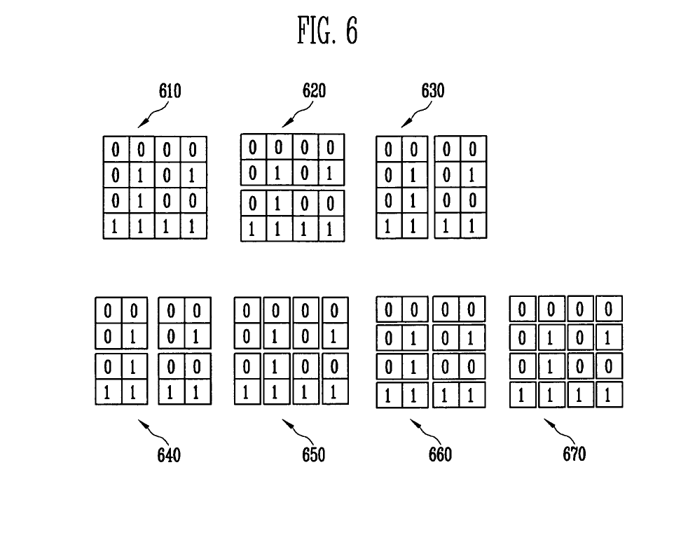

FIG. 5 is a flowchart showing a method of determining a block mode using bit-generation probability estimation according to an exemplary embodiment of the present invention, and FIG. 6 illustrates the method of determining a block mode using bit-generation probability estimation according to an exemplary embodiment of the present invention.

First, when an image frame is input, the motion estimation unit 310 performs motion estimation in units of a main pixel and a sub-pixel using the main pixel prediction module 311 and a sub-pixel prediction module 312, thereby estimating a motion vector (step 510). According to the estimated motion vector, a current macroblock and a reference macroblock corresponding to the current macroblock are determined.

Subsequently, using the bit-generation probability estimator 321, the block mode determination unit 320 calculates an average value and a variance value between the current macroblock and the corresponding reference macroblock determined according to the estimated motion vector (step 520), and then calculates a bit-generation probability estimation value between the blocks using the calculated average value and variance value (step 530).

Subsequently, the block mode determiner 322 of the block mode determination unit 320 checks whether all of 16 bit-generation probability estimation values calculated in step 530 are 0 (step 540). When all of the 16 bit-generation probability estimation values are 0, the block mode determiner 322 determines that a current mode is a skip mode or a direct-prediction mode not requiring additional motion estimation (step 550), and then transfers the determination result to the motion estimation unit 310 to finish motion estimation (step 560).

Meanwhile, when it is checked in step 540 that all of the 16 bit-generation probability estimation values are not 0, the block mode determiner 322 determines that a current mode requires additional motion estimation, performs DCT and quantization, and then calculates a CBP value using the result (step 570). Subsequently, the block mode determiner 322 performs rate-distortion computation using the CBP value (step 580) and selects a block mode having the minimum rate-distortion cost (step 590).

For example, when bit-generation probability estimation results based on the macroblock partition modes illustrated in FIG. 2 are as shown in FIG. 6, a block whose all bit-generation probability estimation values are equal to 0 does not require additional motion estimation for a next block mode. Thus, a current mode is determined as the skip mode or the direct-prediction mode. Consequently, an additional searching process is performed for only a block having a bit-generation probability estimation value of 1 to determine a block mode having a higher compression efficiency, and thus it is possible to minimize the amount of computation for determining a block mode.

In this exemplary embodiment, a block mode is determined through an additional searching process when a bit-generation probability value of a macroblock is 1. However, those skilled in the art can determine a block mode using a clustering algorithm. In this case, needless to say, a reference of a bit-generation probability estimation value requiring the additional searching process may be changed by those skilled in the art.

According to the present invention, whether or not a current mode is a skip mode or a direct-prediction mode is first determined by estimating a bit-generation probability in H.264 video coding for IP-TV, and thus it is possible to reduce unnecessary computation. Therefore, by minimizing the amount of computation for determining a block mode, it is possible to increase an encoding rate and also minimize deterioration in image quality.

While the invention has been shown and described with reference to certain exemplary embodiments thereof, it will be understood by those skilled in the art that various changes in form and details may be made therein without departing from the spirit and scope of the invention as defined by the appended claims.

1. A method of determining a block mode using bit-generation probability estimation in moving picture coding, the method comprising:
performing motion estimation for an input image frame and determining a current macroblock and a corresponding reference macroblock;
calculating an average value and a variance value between the determined current macroblock and the determined corresponding reference macroblock;
calculating a bit-generation probability estimation value between the macroblocks using the average value and the variance value between the macroblocks; and
determining whether or not a current block mode requires additional motion estimation according to the calculated bit-generation probability estimation value.

2. The method of claim 1, wherein in the performing motion estimation for an input image frame and determining a current macroblock and a corresponding reference macroblock, a motion vector is estimated by performing motion estimation on a main pixel and a sub-pixel of the input image frame, and the current macroblock and the corresponding reference macroblock is determined according to the motion vector.

3. The method of claim 1, wherein in the calculating an average value and a variance value between the determined current macroblock and the determined corresponding reference macroblock, the average value m_{4×4} between the macroblocks is calculated by
$${m}_{4 \times 4} = {\sum }_{i = 0}^{3} {\sum }_{j = 0}^{3} ( P ( i , j , t - 1 ) - \overline{P} ( i , j , t ) )$$
wherein P(i,j,t-k) denotes a pixel value in an i-th column and a j-th row of a unit 4×4 block at a time of (t-k), and P̅(i,j,t) denotes a pixel value in an i-th column and a j-th row of a 4×4 block estimated using P(i,j,t-k), and
the variance value V_{4×4} between the macroblocks is calculated by
$${V}_{4 \times 4} = \frac{1}{16} {\sum }_{i = 0}^{3 °} {\sum }_{j = 0}^{3} {( P ( i , j , t - 1 ) - {m}_{4 \times 4} )}^{2}$$
wherein P(i,j,t-k) denotes a pixel value in an i-th column and a j-th row of a unit 4×4 block at a time of (t-k), and m_{4×4} denotes an average value calculated in the unit 4×4 block.

4. The method of claim 1, wherein in the calculating a bit-generation probability estimation value between the macroblocks using the average value and the variance value between the macroblocks, when the input image frame is a Predicted (P) frame, the bit-generation probability estimation value Eh(m_{4×4}, V_{4×4}, QP) between the macroblocks is calculated by
$$Eh ( {m}_{4 \times 4} , {V}_{4 \times 4} , QP ) = \frac{{m}_{4 \times 4} \cdot Q [ ( QP + 12 ) \%6 , 0 , 0 ] + 2 f}{{2}^{16 + \frac{QP + 12}{6}}} + u ( {V}_{4 \times 4} - ( 15 + {θ}_{t} ) )$$
wherein m_{4×4} denotes an average value calculated in a unit 4×4 block, V_{4×4} denotes a variance value calculated in the unit 4×4 block, QP denotes a quantization coefficient of H.264, Q[(QP+12) % 6, i, j) denotes a quantization function of QP, i and j depending on i, j and a remainder obtained by dividing a result of adding 12 to the quantization coefficient by 6, f denotes a quantization level offset value, u(x) denotes a unit step function having a value of 1 when x≧0 and a value of 0 when x<0, and θ denotes a threshold value for estimating a bit-generation probability and is calculated by a least square method to be 2.5 to 3.5.

5. The method of claim 1, wherein in the calculating a bit-generation probability estimation value between the macroblocks using the average value and the variance value between the macroblocks, when the input image frame is a Bidirectionally predicted (B) frame, the bit-generation probability estimation value Eh(m_{4×4}, V_{4×4}, QP) between the macroblocks is calculated by
$$Eh ( {m}_{4 \times 4} , {V}_{4 \times 4} , QP ) = \frac{{m}_{4 \times 4} \cdot Q [ ( QP + 12 ) \%6 , 0 , 0 ] + 2 f}{{2}^{16 + \frac{QP + 12}{6}}}$$
wherein m_{4×4} denotes an average value calculated in a unit 4×4 block, V_{4×4} denotes a variance value calculated in the unit 4×4 block, QP denotes a quantization coefficient of H.264, Q[(QP+12) % 6, i, j) denotes a quantization function of QP, i and j depending on i, j and a remainder obtained by dividing a result of adding 12 to the quantization coefficient by 6, and f denotes a quantization level offset value.

6. The method of claim 1, wherein in the determining whether or not a current block mode requires additional motion estimation according to the calculated bit-generation probability estimation value, the current block mode is determined to be a block mode not requiring additional motion estimation when the bit-generation probability estimation value between the macroblocks is 0, and is determined to be a block mode requiring additional motion estimation when the bit-generation probability estimation value between the macroblocks is not 0.

7. The method of claim 6, wherein when the bit-generation probability estimation value between the macroblocks is 0, and the input image frame is a Predicted (P) frame, the current block mode is determined to be a skip mode not requiring additional motion estimation for the P frame, and when the bit-generation probability estimation value between the macroblocks is 0, and the input image frame is a Bidirectionally predicted (B) frame, the current block mode is determined to be a direct-prediction mode not requiring additional motion estimation for the B frame.

8. The method of claim 6, when the bit-generation probability estimation value between the macroblocks is not 0, further comprising:
performing additional motion estimation for the current macroblock and calculating a Coded Block Pattern (CBP) value for the current macroblock on which additional motion estimation is performed; and
performing rate-distortion computation using the CBP value and determining a block mode having a minimum rate-distortion cost.

9. An apparatus for determining a block mode using bit-generation probability estimation in moving picture coding, the apparatus comprising:
a motion estimator comprising:
a motion estimation unit for performing motion estimation for an input image frame; and
a block mode determination unit for determining whether or not a current block mode requires additional motion estimation using an average value and a variance value between a current macroblock determined by the motion estimation and a corresponding reference macroblock.

10. The apparatus of claim 9, wherein the block mode determination unit comprises:
a bit-generation probability estimator for calculating the average value and the variance value between the current macroblock determined by the motion estimation and the corresponding reference macroblock to calculate the bit-generation probability estimation value; and
a block mode determiner for determining whether or not the current block mode is a block mode requiring additional motion estimation according to the calculated bit-generation probability estimation value.

11. The apparatus of claim 10, wherein the block mode determiner determines the current block mode as a skip mode or a direct-prediction mode not requiring additional motion estimation when the calculated bit-generation probability estimation value between the macroblocks is 0, and determines the current block mode as a block mode requiring additional motion estimation when the bit-generation probability estimation value between the macroblocks is not 0.

12. The apparatus of claim 9, wherein when the block mode determination unit determines the current block mode of the current macroblock as a block mode requiring additional motion estimation, the motion estimation unit performs additional motion estimation for the current macroblock.

13. The apparatus of claim 12, wherein the block mode determination unit calculates a Coded Block Pattern (CBP) value for the current macroblock on which additional motion estimation is performed, performs rate-distortion computation using the CBP value, and determines a block mode having a minimum rate-distortion value.
